(19) United States
(12) Patent Application Publication
(10) Pub. No.: US 2026/0163602 A1
(43) Pub. Date: Jun. 11, 2026

(54) COMMUNICATION DEVICE AND COMMUNICATION SYSTEM USING SURFACE WAVE SIGNALS AND METHOD OF OPERATING THE SAME

(71) Applicant: ELECTRONICS AND TELECOMMUNICATIONS RESEARCH INSTITUTE, Daejeon (KR)

(72) Inventors: SEOK BONG HYUN, Daejeon (KR); Seunghyun JANG, Daejeon (KR); WONYOUNG SONG, Daejeon (KR)

(21) Appl. No.: 19/404,422

(22) Filed: Dec. 1, 2025

(30) Foreign Application Priority Data
Dec. 6, 2024 (KR) 10-2024-0180262

(51) Int. Cl. H04B 1/44

(52) U.S. Cl. CPC H04B 1/44

(57) ABSTRACT

The communication device comprises an antenna device configured to receive a surface wave signal from an external communication device through a medium including a surface of a metal layer, to receive a space wave signal from the external communication device through free space, and to select a first communication signal corresponding to a selected one of the surface wave signal and the space wave signal by using switches, and a communication modem configured to calculate an error vector magnitude (EVM) value, to determine whether the EVM value exceeds a first threshold value, and to provide a switch control signal to the antenna device in response to determining that the EVM value exceeds the first threshold value. The antenna device is further configured to receive or generate a second communication signal different from the selected one of the surface wave signal and the space wave signal.

### CROSS-REFERENCE TO RELATED APPLICATION

This application claims priority under 35 U.S.C. § 119 to Korean Patent Application No. 10-2024-0180262 filed on Dec. 6, 2024, in the Korean Intellectual Property Office, the disclosures of which are incorporated by reference herein in their entireties.

### BACKGROUND

The present disclosure relates to communication devices, and more particularly to communication devices and communication systems using surface waves, and methods of operating the same.

A communication device exchanges communication signals with another communication device. The communication signals may be space wave signals transmitted through three-dimensional free space, and may be surface wave signals transmitted through the surface of a medium.

When a structure that causes scattering and reflection of space wave signals exists between a communication device and other communication devices, the space wave signals may act as interferer to the surface wave signals and degrade the signal-to-interference-plus-noise ratio (SINR) of communication signals. Therefore, there is a need for designing communication devices that analyze characteristics of communication signals and improve the SINR of the communication signals based thereon.

### SUMMARY

According to an embodiment of the present disclosure, a communication device and a communication system using surface waves, and a method of operating the same are provided. Surface wave means an electromagnetic (EM) wave mode propagating two-dimensionally along the boundary between two different media, for example, air and a metal layer or air and a dielectric layer on a metal layer.

According to an embodiment of the present disclosure, a communication device comprises an antenna device configured to receive a surface wave signal from an external communication device through a medium including a surface of a metal layer, to receive a space wave signal from the external communication device through free space, and to select a first communication signal corresponding to a selected one of the surface wave signal and the space wave signal by using switches, and a communication modem configured to calculate an error vector magnitude (EVM) value, to determine whether the EVM value exceeds a first threshold value, and to provide a switch control signal to the antenna device in response to determining that the EVM value exceeds the first threshold value. The antenna device is further configured to receive or generate a second communication signal different from the selected one of the surface wave signal and the space wave signal. The antenna device includes an antenna switch. The communication modem configured to calculate the EVM value based on the first communication signal or the second communication signal though the antenna switch. The medium includes a conductor layer or a dielectric layer. The surface wave signal is transmitted along the surface of the conductor layer or the dielectric layer.

According to an embodiment of the present disclosure, the antenna device includes a surface wave antenna and the surface wave antenna includes an insulating substrate in contact with a medium including a metallic surface (or a metal or the dielectric layer), a first metal layer performing impedance matching of the surface wave signal, and a second metal layer receiving the surface wave signal and providing electrical connection to the antenna switch.

According to an embodiment of the present disclosure, the antenna device includes a space wave antenna and an antenna switch, and the space wave antenna includes a patch antenna layer receiving the space wave signal.

According to an embodiment of the present disclosure, the antenna device includes a surface wave antenna, a space wave antenna, a common ground layer, and an antenna switch, the surface wave antenna includes an insulating substrate in contact with a medium including a metallic surface (or a metal or the dielectric layer), a first metal layer performing impedance matching of the surface wave signal, and a second metal layer receiving the surface wave signal and providing electrical connection to the antenna switch, the space wave antenna includes a patch antenna layer receiving the space wave signal, and the common ground layer is configured to be positioned between the surface wave antenna and the space wave antenna and to receive a ground signal (for example, ground voltage).

According to an embodiment of the present disclosure, the conductor layer includes a long metallic stripe, a large metal plate, and a metallic wire in the form of a mesh.

According to an embodiment of the present disclosure, the medium including a metal layer is rollable.

According to an embodiment of the present disclosure, the communication modem is configured to provide the switch control signal to the antenna device in response to determining that the estimated EVM value of the first communication signal including a surface wave signal exceeds the first threshold value.

According to an embodiment of the present disclosure, the EVM value is calculated by demodulating a part of preamble signal within the first communication signal, where an example of a part of preamble is the long training field (LTF) signal specified by a packet frame structure according to the IEEE 802.11 standard.

According to an embodiment of the present disclosure, the communication device includes a receiver configured to receive the first communication signal from the antenna device, to amplify the first communication signal, and to provide the amplified and down-converted first communication signal to the communication modem.

According to an embodiment of the present disclosure, a method of operating a communication device including an antenna device and a communication modem is provided. The method includes receiving a surface wave signal by using an antenna through a medium including a long metallic stripe or a large metal plate, receiving a space wave signal through free space, generating a first communication signal corresponding to a selected one of the surface wave signal and the space wave signal, calculating an EVM value based on the first communication signal, determining whether the EVM value exceeds a first threshold value, generating a switch control signal in response to determining that the EVM value exceeds the first threshold value, and selecting, based on the switch control signal, a second communication signal different from the selected one of the surface wave signal and the space wave signal. The medium includes a conductor including a metallic stripe or a large metal plate (or including a conductor layer or a dielectric layer), and the surface wave signal is transmitted along a surface of the metallic stripe or the large metal plate (or along a surface of the conductor layer or the dielectric layer).

According to an embodiment of the present disclosure, the antenna device includes a surface wave antenna and an antenna switch, and the receiving of the surface wave signal through the medium includes receiving the surface wave signal through an insulating substrate connected to the medium, performing an impedance matching of the surface wave signal, and providing the matched surface wave signal to the antenna switch.

According to an embodiment of the present disclosure, the conductor layer includes a long metallic stripe and a metallic wire in the form of a mesh.

According to an embodiment of the present disclosure, the medium is rollable.

According to an embodiment of the present disclosure, the generating of the switch signal includes calculating a BER value based on the first communication signal, determining whether the BER value exceeds a second threshold value, and generating the switch signal in response to determining that the EVM value exceeds the first threshold value or determining that the BER value exceeds the second threshold value.

According to an embodiment of the present disclosure, the generating of the switch control signal includes calculating an EVM value based on the first communication signal by demodulating a part of preamble signal within the first communication signal, where an example of a part of preamble is the long training field (LTF) signal specified by a packet frame structure according to the IEEE 802.11 standard.

According to an embodiment of the present disclosure, a communication system is provided. The communication system includes a first communication device, a second communication device, and a medium. The first communication device includes a first communication modem configured to generate a first communication signal, and a first antenna device configured to generate a surface wave signal and a space wave signal based on the first communication signal, to provide the surface wave signal to the medium, and to radiate the space wave signal into the free space. The second communication device includes a second antenna device configured to receive the surface wave signal through the medium, to receive the space wave signal through the free space, and to generate a second communication signal corresponding to a selected one of the surface wave signal and the space wave signal, and a second communication modem configured to calculate an EVM value based on the second communication signal, to determine whether the EVM value exceeds a first threshold value, and to provide a switch control signal to the second antenna device in response to determining that the EVM value exceeds the first threshold value. The second antenna device is configured to generate a third communication signal different from the selected one of the surface wave signal and the space wave signal, based on the switch control signal, and the medium includes a conductor layer or a dielectric layer formed on the conductor layer, and the surface wave signal is transmitted along the surface of the conductor layer or the dielectric layer.

According to an embodiment of the present disclosure, the second antenna device includes a surface wave antenna and an antenna switch, and the surface wave antenna includes an insulating substrate in contact with a medium including a metal or dielectric layer, a first metal layer performing impedance matching of the surface wave signal, and a second metal layer providing the matched surface wave signal to the antenna switch.

According to an embodiment of the present disclosure, the second antenna device includes a space wave antenna and an antenna switch, and the space wave antenna includes a patch antenna layer receiving the space wave signal.

According to an embodiment of the present disclosure, the second antenna device includes a surface wave antenna, a space wave antenna, a common ground layer, and an antenna switch, the surface wave antenna includes an insulating substrate in contact with a medium including as a metal or dielectric layer, a first metal layer performing an impedance matching of the surface wave signal, and a second metal layer providing the matched surface wave signal to the antenna switch, the space wave antenna includes a patch antenna layer receiving the space wave signal, and the ground layer is positioned between the surface wave antenna and the space wave antenna and receives a ground signal (for example, a ground voltage).

According to an embodiment of the present disclosure, the conductor layer includes a long metallic stripe, a large metal plate, and a metallic wire in the form of a mesh.

According to an embodiment of the present disclosure, the medium is rollable.

According to an embodiment of the present disclosure, the second communication modem is configured to calculate a BER value based on the second communication signal, to determine whether the BER value exceeds a second threshold value, and to provide the switch signal to the antenna device in response to determining that the EVM value exceeds the first threshold value or determining that the BER value exceeds the second threshold value.

### BRIEF DESCRIPTION OF THE FIGURES

The above and other objects and features of the present disclosure will become apparent by describing in detail embodiments thereof with reference to the accompanying drawings.

FIG. 1 is a diagram illustrating a communication system according to an embodiment of the present disclosure.

FIG. 2 is a diagram illustrating a first communication device according to some embodiments of the present disclosure.

FIG. 3 is a diagram illustrating a second communication device according to some embodiments of the present disclosure.

FIG. 4 is a diagram illustrating a communication device according to some embodiments of the present disclosure.

FIG. 5 is a diagram illustrating an antenna device according to some embodiments of the present disclosure.

FIG. 6 is a diagram illustrating a communication signal according to some embodiments of the present disclosure.

### DETAILED DESCRIPTION

Hereinafter, embodiments of the present disclosure will be described clearly and in detail to such an extent that a person having ordinary skill in the art of the present disclosure may easily practice the present disclosure.

Hereinafter, terms such as “unit” and “module” used herein or functional blocks shown in the drawings may be implemented in the form of software components, hardware components, or combinations thereof. Hereinafter, to clearly describe the technical concept of the present disclosure, detailed descriptions of redundant components may be omitted.

As used herein, including in the claims, phrases such as “A or B,” “at least one of A and B,” “at least one of A or B,” “A, B, or C,” “at least one of A, B, and C,” and “at least one of A, B, or C” may each include any one of the items listed together in the corresponding phrase, or all possible combinations thereof.

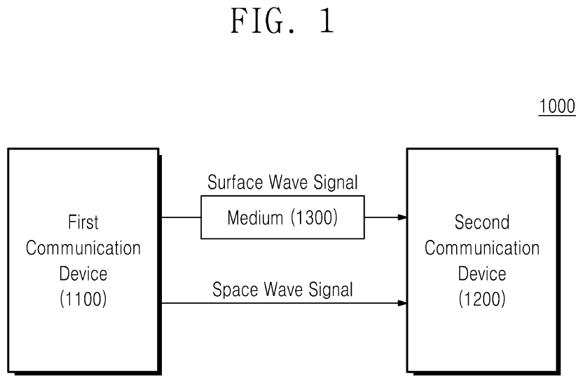

FIG. 1 is a block diagram of a communication system according to an embodiment of the present disclosure. Referring to FIG. 1, the communication system 1000 may include a first communication device 1100, a second communication device 1200, and a medium 1300 including a surface of a metal layer.

The first communication device 1100 may generate a surface wave signal and a space wave signal. The space wave signal may be a communication signal transmitted through free space. The surface wave signal may be a signal transmitted through the medium 1300. For example, the surface wave signal may have the form of an electromagnetic wave and propagating two-dimensionally along the boundary between two different media, for example, air and a metal layer or air and a dielectric layer on a metal layer.

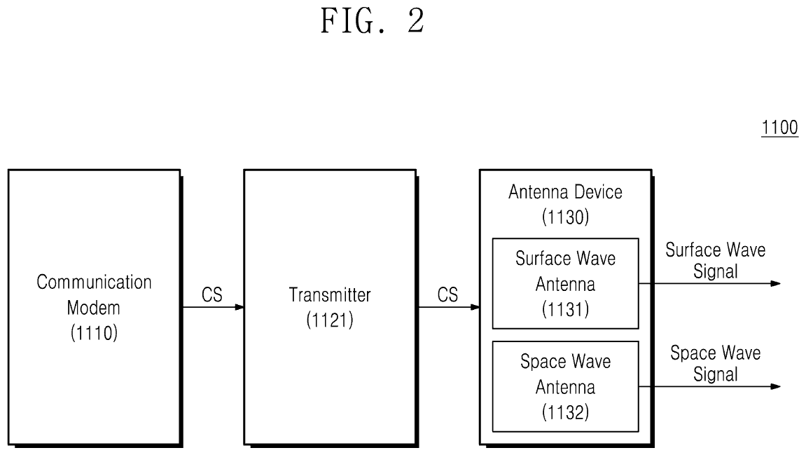

The first communication device 1100 may radiate a space wave signal into free space and may provide a surface wave signal to the medium 1300. A more detailed description of the first communication device 1100 will be described below with reference to FIG. 2.

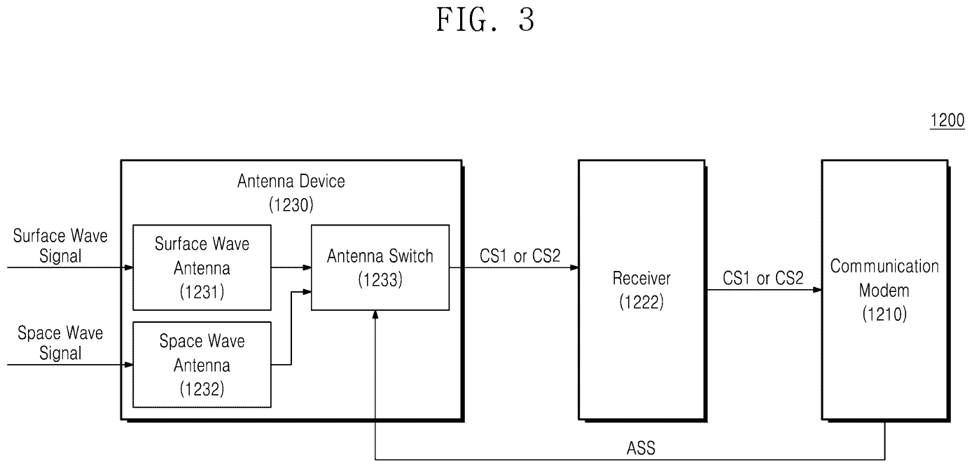

The second communication device 1200 may receive a space wave signal through free space and may receive a surface wave signal through the medium 1300. A more detailed description of the second communication device 1200 will be described below with reference to FIG. 3.

In some embodiments, the medium 1300 may comprise a conductor layer and a dielectric layer formed on the conductor layer. The surface wave signal may be transmitted through the dielectric layer. For example, the conductor layer may comprise a metal wire in the form of a mesh.

In some embodiments, the medium 1300 may be rollable.

FIG. 2 is a diagram illustrating a first communication device according to some embodiments of the present disclosure. Referring to FIGS. 1 and 2, the first communication device 1100 may include a communication modem 1110, a transmitter 1121, and an antenna device 1130.

The communication modem 1110 may generate a communication signal CS. The communication modem 1110 may provide the communication signal CS to the transmitter 1121 or the antenna device 1130.

The transmitter 1121 may receive the communication signal CS. The transmitter 1121 may amplify the communication signal CS or filter a specific frequency component of the communication signal CS. The transmitter 1121 may provide the amplified or filtered communication signal CS to the antenna device 1130. In some embodiments, the transmitter 1121 may include a power amplifier, a local oscillator, and a filter.

The antenna device 1130 may receive the communication signal CS and generate a surface wave signal and a space wave signal based on the communication signal CS. The antenna device 1130 may provide the surface wave signal to the medium 1300. The antenna device 1130 may radiate the space wave signal into free space.

In some embodiments, the antenna device 1130 may include a surface wave antenna 1131 and a space wave antenna 1132. The surface wave antenna 1131 may generate a surface wave signal based on the communication signal CS. The surface wave antenna 1131 may provide the generated surface wave signal to the medium 1300. The space wave antenna 1132 may generate a space wave signal based on the communication signal CS. The space wave antenna 1132 may radiate the generated space wave signal into free space.

FIG. 3 is a diagram illustrating a second communication device according to some embodiments of the present disclosure. Referring to FIGS. 1 and 3, the second communication device 1200 may include a communication modem 1210, a receiver 1222, and an antenna device 1230.

The antenna device 1230 may receive surface wave signals and space wave signals, and may select a first communication signal corresponding to a selected one of the surface wave signals and space wave signals by switches.

The antenna device 1230 may include a surface wave antenna 1231, a space wave antenna 1232, and an antenna switch 1233. The surface wave antenna 1231 may receive a surface wave signal through a medium 1300. The surface wave antenna 1231 may provide the received surface wave signal to the antenna switch 1233. The space wave antenna 1232 may receive a space wave signal through free space. The space wave antenna 1232 may provide the received space wave signals to the antenna switch 1233.

The antenna switch 1233 may select one of the surface wave signal and the space wave signal. The selected signal may correspond to a first communication signal CS1. The antenna switch 1233 may provide the first communication signal CS1 to the receiver 1222 or the communication modem 1210.

The communication modem 1210 may calculate an Error Vector Magnitude (EVM) value based on the first communication signal CS1 or the second communication signal. The communication modem 1210 may determine whether the EVM value exceeds a first threshold value. The communication modem 1210 may generate an antenna switch signal ASS in response to determining that the EVM value exceeds the first threshold value. The communication modem 1210 may provide the antenna switch signal ASS to the antenna switch 1233.

The receiver 1222 may amplify the first communication signal CS1 or filter a specific frequency component of the first communication signal CS1. The receiver 1222 may provide the amplified or filtered first communication signal CS1 to the communication modem 1210. In some embodiments, the receiver may include a low-noise amplifier, a local oscillator, and a filter.

The antenna switch 1233 may generate a second communication signal CS2 different from the selected one of the surface wave signal and the space wave signal, based on the antenna switch signal ASS. For example, when the first communication signal CS1 corresponds to the surface wave signal and the EVM value calculated based on the surface wave signal exceeds the threshold value, the antenna switch 1233 may provide a second communication signal CS2 corresponding to the space wave signal to the communication modem 1210.

In some embodiments, the communication modem 1210 may calculate a Bit Error Rate (BER) value based on the first communication signal CS1. The communication modem 1210 may determine whether the BER value exceeds a second threshold value, and may provide a switch signal to the antenna switch 1233 in response to determining that the EVM value exceeds a first threshold value or determining that the BER value exceeds the second threshold value.

When a structure exists between the communication device and another communication device that causes scattering and absorption of space wave signals, the space wave signals may act as noise, thereby degrading the signal-to-noise ratio (SNR) of the communication signal.

The EVM value and BER value of the space wave signal may serve as criteria for determining whether the space wave signal acts as noise. By controlling the switching operation of the antenna device 1230 based on the EVM value and BER value, communication signals with low SNR or severe fading may be excluded from the overall communication signal. Accordingly, the SNR of the communication signal may be improved.

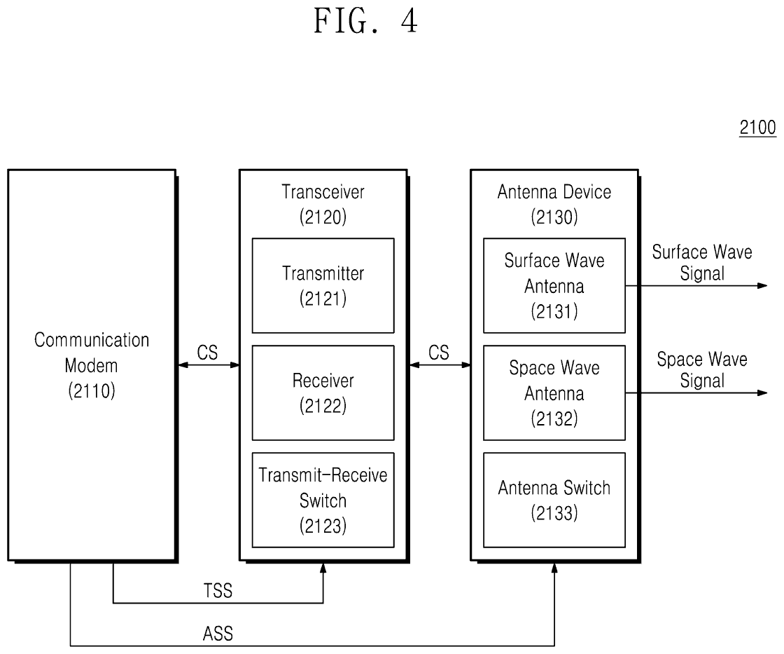

FIG. 4 is a diagram illustrating a communication device according to some embodiments of the present disclosure. Referring to FIGS. 2 to 4, the communication device 2100 may include a communication modem 2110, a transceiver 2120, and an antenna device 2130.

The first communication device 1100 and the second communication device 1200 may be implemented as a single communication device 2100. For example, the transceiver 2120 may include a transmitter 1121 and a receiver 1222, and the antenna device 2130 may include an antenna device 1130 and an antenna device 1230. For concise description, explanations overlapping with FIGS. 2 and 3 may be omitted below in FIG. 4.

The communication modem 2110 may generate a communication signal CS and provide it to the transceiver 2120. The communication modem 2110 may receive a communication signal CS from the transceiver 2120 and, based on the received communication signal CS, calculate an EVR value and a BER value. In some embodiments, the communication modem 2110 may modulate and demodulate the communication signal CS.

The communication modem 2110 may provide a transmit-receive switch signal TSS to the transceiver 2120. The communication modem 2110 may provide an antenna switch signal ASS to the antenna device 2130.

The transceiver 2120 may include a transmitter 2121, a receiver 2122, and a transmit-receive switch 2123. The transmit-receive switch 2123 may perform switching operations of the transmitter 2121 and the receiver 2122 based on a transmit-receive switch signal TSS. For example, when the transmit-receive switch 2123 receives a transmit-receive switch signal TSS indicating a receive operation, the transmit-receive switch 2123 may deactivate the operation of the transmitter 2121 and activate the operation of the receiver 2122.

The antenna device 2130 may include a surface wave antenna 2131, a space wave antenna 2132, and an antenna switch 2133. The antenna switch 2133 may perform switching operations of the surface wave antenna 2131 and the space wave antenna 2132 based on an antenna switch signal ASS. For example, when the antenna switch 2133 receives an antenna switch signal ASS indicating a surface wave signal, the antenna switch 2133 may deactivate the operation of the space wave antenna 2132 and activate the operation of the surface wave antenna 2131.

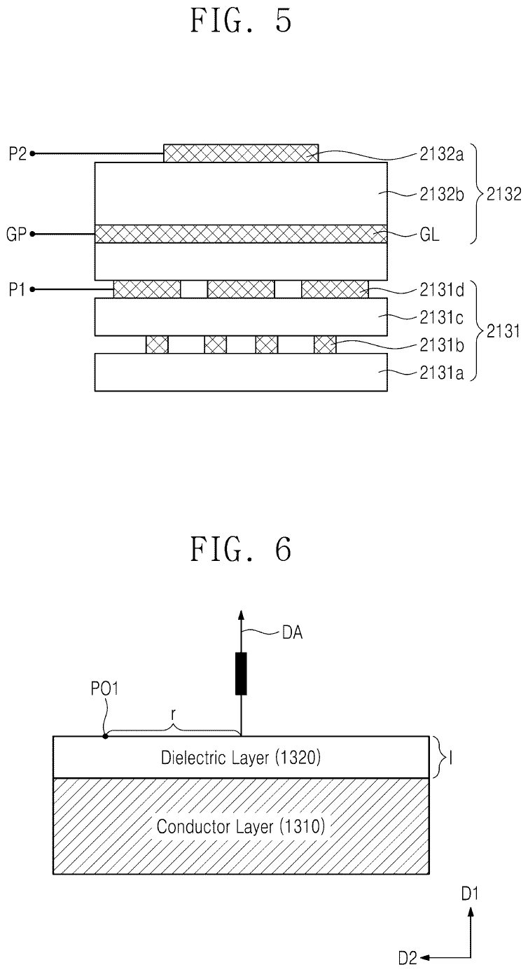

FIG. 5 is a diagram illustrating an antenna device according to some embodiments of the present disclosure. Referring to FIGS. 1, 4, and 5, the antenna device 2130 may include a surface wave antenna 2131 and a space wave antenna 2132.

The surface wave antenna 2131 may comprise a first insulating substrate 2131a connected to the medium 1300 and receiving the surface wave signal, a first metal layer 2131b performing impedance matching of the surface wave signal, a second metal layer 2131d providing the surface wave signal to the antenna switch 2133 through a first port P1, and an insulating layer 2131c between the first metal layer 2131b and the second metal layer 2131d.

The second metal layer 2131d may receive a communication signal CS through the first port P1. The second metal layer 2131d may generate a surface wave signal based on the communication signal CS. The first metal layer 2131b may perform impedance matching of the generated surface wave signal. The first insulating substrate 2131a may be connected to the medium 1300 and may provide the surface wave signal to the medium.

The space wave antenna 2132 may comprise a second insulating substrate 2132b and a patch antenna layer 2132a on the second insulating substrate 2132b. The patch antenna layer 2132a may receive space wave signals through free space and may provide the received space wave signals to the antenna switch 2133 through a second port P2.

The patch antenna layer 2132a may receive a communication signal CS through the second port P2. The patch antenna layer 2132a may generate a space wave signal based on the received communication signal CS and radiate the generated space wave signal into free space.

The antenna device 2130 may include a ground layer GL that receives a ground voltage through a ground port GP. The ground layer GL may provide the ground voltage to the surface wave antenna 2131 and the space wave antenna 2132. In some embodiments, the ground layer GL may be positioned between the surface wave antenna 2131 and the space wave antenna 2132.

FIG. 6 is a diagram illustrating a communication signal according to some embodiments of the present disclosure. Referring to FIGS. 1 and 6, the magnitude of signal power of the communication signal according to distance from the antenna is described.

The medium 1300 may include a conductor layer 1310 and a dielectric layer 1320 on the conductor layer 1310. The surface wave signal may be transmitted through the dielectric layer 1320. The space wave signal may be transmitted through free space. Free space may refer to any space excluding the medium 1300.

Hereinafter, for convenience of description, a first direction D1 and a second direction D2 are described. The first direction D1 may be perpendicular to the conductor layer 1310 and the dielectric layer 1320. The second direction D2 may be perpendicular to the first direction D1.

A dipole antenna DA extending in the first direction D1 may generate a communication signal. The communication signal may correspond to at least one of the surface wave signal and the space wave signal. Since the surface wave signal is transmitted through the dielectric layer 1320 and the space wave signal is transmitted through the free space, the communication signal CS at the boundary of the free space and the dielectric layer 1320 may include a surface wave signal component and a space wave signal component.

The first point PO1 is located a second length r in the second direction D2 from a contact point of the dielectric layer 1320 and the dipole antenna DA. The first point PO1 may be located at the boundary between the dielectric layer 1320 and free space. The power magnitude of the communication signal at the first point PO1 is given by Equation 1.

$${P}_{Rx} ( r ) \approx {P}_{Tx} \cdot ( 1 - {10}^{( {S}_{11} {\vert}_{dB} ) / 10} ) \cdot ( \frac{{A}_{0}}{{r}^{2}} + \frac{{B}_{0}}{r} ) \qquad [ Equation 1 ]$$

Here, PRx indicates the power magnitude of the communication signal at the first point PO1, PTx indicates the power magnitude of the communication signal at the dipole antenna DA, and S11 indicates the antenna impedance expressed in decibels (dB).

The communication signal at the first point PO1 includes a space wave signal component and a surface wave signal component. According to Equation 1, the power magnitude of the communication signal due to the space wave signal component is inversely proportional to the square of the second length r and proportional to coefficient A0. The power magnitude of the communication signal due to the surface wave signal component is inversely proportional to the second length r and proportional to coefficient B0.

$${B}_{0} ∝ {( l \cdot {f}_{0}^{2} ( {ε}_{r} - 1 ) / {ε}_{r} )}^{2} \qquad [ Equation 2 ]$$

According to Equation 2, the coefficient B0 affecting the power magnitude of the communication signal by the surface wave signal component is described. f0 denotes the frequency of the surface wave signal. The coefficient B0 is proportional to the first length l in the first direction D1 of the dielectric layer 1320 and f.

According to Equations 1 and 2, it is described that as the distance from the antenna generating the communication signal increases, the space wave signal component of the communication signal decreases faster than the surface wave signal component.

According to an embodiment of the present disclosure, a communication device using surface waves, a communication system, and a method of operating the same are provided.

According to an embodiment of the present disclosure, signal-to-noise ratio (SNR) of a communication signal may be improved by calculating error vector magnitude (EVM) values of a surface wave signal and a space wave signal and selectively receiving the surface wave signal and the space wave signal.

The above-described content represents specific embodiments for implementing the present disclosure. The present disclosure will include not only the above-described embodiments, but also embodiments that are simply modified in design or may be easily changed. Furthermore, the present disclosure will also include techniques that may be easily modified and implemented using the embodiments. Therefore, the scope of the present disclosure should not be limited to the above-described embodiments, but should be determined by the claims described below as well as equivalents to the claims of this disclosure.

What is claimed is:

1. A communication device comprising:
an antenna device configured to receive a surface wave signal from an external communication device through a medium including a surface of a metal layer, to receive a space wave signal from the external communication device through free space, and to select a first communication signal corresponding to a selected one of the surface wave signal and the space wave signal by using switches; and
a communication modem configured to calculate an error vector magnitude (EVM) value, to determine whether the EVM value exceeds a first threshold value, and to provide a switch control signal to the antenna device in response to determining that the EVM value exceeds the first threshold value,
wherein the antenna device is further configured to receive or generate a second communication signal different from the selected one of the surface wave signal and the space wave signal,
wherein the antenna device includes an antenna switch,
wherein the communication modem configured to calculate the EVM value based on the first communication signal or the second communication signal though the antenna switch,
wherein the medium includes a conductor layer or a dielectric layer, and
wherein the surface wave signal is transmitted along the surface of the conductor layer or the dielectric layer.

2. The communication device of claim 1, wherein the antenna device includes a surface wave antenna, and
wherein the surface wave antenna includes an insulating substrate in contact with a medium including a metal or the dielectric layer, a first metal layer performing impedance matching of the surface wave signal, and a second metal layer receiving the surface wave signal and providing electrical connection to the antenna switch.

3. The communication device of claim 1, wherein the antenna device includes a space wave antenna, and
wherein the space wave antenna includes a patch antenna layer receiving the space wave signal.

4. The communication device of claim 1, wherein the antenna device includes a surface wave antenna, a space wave antenna, a common ground layer, and an antenna switch,
wherein the surface wave antenna includes an insulating substrate in contact with a medium including a metal or dielectric layer, a first metal layer performing impedance matching of the surface wave signal, and a second metal layer receiving the surface wave signal and providing electrical connection to the antenna switch,
wherein the space wave antenna includes a patch antenna layer receiving the space wave signal, and
wherein the common ground layer is configured to be positioned between the surface wave antenna and the space wave antenna and to receive a ground signal.

5. The communication device of claim 1, wherein the conductor layer includes a long metallic stripe, a large metal plate, and a metallic wire in the form of a mesh.

6. The communication device of claim 1, wherein the medium including a metal layer is rollable.

7. The communication device of claim 1, wherein the EVM value is calculated by demodulating a part of preamble signal within the first communication signal, where an example of a part of preamble is the long training field (LTF) signal specified by a packet frame structure according to the IEEE 802.11 standard.

8. The communication device of claim 1, wherein the communication device includes a receiver configured to receive the first communication signal from the antenna device, to amplify the first communication signal, and to provide the amplified and down-converted first communication signal to the communication modem.

9. A method of operating a communication device including an antenna device and a communication modem, the method comprising:
receiving a surface wave signal by using an antenna through a medium including a long metallic stripe or a large metal plate;
receiving a space wave signal from the external communication device through free space;
generating a first communication signal corresponding to a selected one of the surface wave signal and the space wave signal;
calculating an EVM value based on the first communication signal;
determining whether the EVM value exceeds a first threshold value;
generating a switch control signal in response to determining that the EVM value exceeds the first threshold value; and
selecting, based on the switch signal, a second communication signal different from the selected one of the surface wave signal and the space wave signal,
wherein the medium includes a conductor layer or a dielectric layer, and
wherein the surface wave signal is transmitted along a surface of the conductor layer or the dielectric layer.

10. The method of claim 9, wherein the antenna device includes a surface wave antenna and an antenna switch, and
wherein the receiving of the surface wave signal from the external communication device through the medium includes:
receiving the surface wave signal through an insulating substrate connected to the medium;
performing an impedance matching of the surface wave signal; and
providing the matched surface wave signal to the antenna switch.

11. The method of claim 9, wherein the conductor layer includes a long metallic stripe and a metallic wire in the form of a mesh.

12. The method of claim 9, wherein the medium is rollable.

13. The method of claim 9, wherein the generating of the switch control signal includes calculating an EVM value based on the first communication signal by demodulating a part of preamble signal within the first communication signal, where an example of a part of preamble is the long training field (LTF) signal specified by a packet frame structure according to the IEEE 802.11 standard.

14. A communication system comprising:
a first communication device, a second communication device, and a medium,
wherein the first communication device includes:
a first communication modem configured to generate a first communication signal; and
a first antenna device configured to generate a surface wave signal and a space wave signal based on the first communication signal, to provide the surface wave signal to the medium, and to radiate the space wave signal into the free space,
wherein the second communication device includes:
a second antenna device configured to receive the surface wave signal through the medium, to receive the space wave signal through the free space, and to generate a second communication signal corresponding to a selected one of the surface wave signal and the space wave signal; and
a second communication modem configured to calculate an EVM value based on the second communication signal, to determine whether the EVM value exceeds a first threshold value, and to provide a switch control signal to the second antenna device in response to determining that the EVM value exceeds the first threshold value,
wherein the second antenna device is configured to generate a third communication signal different from the selected one of the surface wave signal and the space wave signal, based on the switch control signal,
wherein the medium includes a conductor layer or a dielectric layer, and
wherein the surface wave signal is transmitted along the surface of the conductor layer or the dielectric layer.

15. The communication system of claim 14, wherein the second antenna device includes a surface wave antenna and an antenna switch, and
wherein the surface wave antenna includes an insulating substrate in contact with a medium including a metal or dielectric layer, a first metal layer performing impedance matching of the surface wave signal, and a second metal layer providing the matched surface wave signal to the antenna switch.

16. The communication system of claim 14, wherein the second antenna device includes a space wave antenna and an antenna switch, and
wherein the space wave antenna includes a patch antenna layer receiving the space wave signal.

17. The communication system of claim 14, wherein the second antenna device includes a surface wave antenna, a space wave antenna, a common ground layer, and an antenna switch,
wherein the surface wave antenna includes an insulating substrate in contact with a medium including as a metal or dielectric layer, a first metal layer performing an impedance matching of the surface wave signal, and a second metal layer providing the matched surface wave signal to the antenna switch,
wherein the space wave antenna includes a patch antenna layer receiving the space wave signal, and
wherein the ground layer is positioned between the surface wave antenna and the space wave antenna and receives a ground signal.

18. The communication system of claim 14, wherein the conductor layer includes a long metallic stripe, a large metal plate, and a metallic wire in the form of a mesh.

19. The communication system of claim 14, wherein the medium is rollable.
